(19) United States
(12) Patent Application Publication
(10) Pub. No.: US 2019/0191756 A1
(43) Pub. Date: Jun. 27, 2019

(54) METHOD AND SYSTEM FOR WASHING GRAPES, ESPECIALLY GRAPES FOR WINEMAKING

(71) Applicant: Turatti S.R.L., Venezia (IT)

(72) Inventor: Antonio TURATTI, Venezia (IT)

(73) Assignee: Turatti S.R.L., Venezia (IT)

(21) Appl. No.: 16/328,724

(22) PCT Filed: Sep. 15, 2017
(86) PCT No.: PCT/IT2017/000197

§ 371 Date: Feb. 27, 2019

(30) Foreign Application Priority Data
Sep. 23, 2016 (IT) 102016000095728

(51) Int. Cl. A23N 12/06; A23B 7/158; A23B 7/154; A23B 7/157; A23L 3/3499; A23L 3/358

(52) U.S. Cl. CPC A23N 12/06; A23B 7/158; A23B 7/154; A23V 2002/00; A23L 3/3499; A23L 3/358; A23B 7/157

(57) ABSTRACT

Process and plant for washing of grapes especially for wine making comprising:
a first stage of automated washing able to remove substances and/or foreign bodies from the grapes at least through the effect of chemical agents;
a second stage of automated washing to remove chemical agents from the grape;

the phases of washing being such as to preserve the integrity and the organoleptic qualities of the grape.

The present invention relates to a process and a plant for grape washing, especially for vinification.

In particular, the present invention relates to a plant and a process which allows for optimal washing of grape destined for winemaking and particularly for the production of high quality wines.

Therefore, the present invention is in the field of plants and processes of treatment of the grape.

Nowadays, the more and more consistent use of phytosanitary products in treatments in field, and the noticeable increasing air and environmental pollution, are among the main causes of health and oenological problems.

The consumer is always more sensitive to the healthiness of the product he/she buys and, the competent bodies, regulate the use of phytosanitary products by imposing more rigid and restrictive regulations.

Especially in the production of high quality wines, maximum care and attention is required in all the processing stages of the grape, from the vine to pressing. These wines must be free of defects and exempted from external contamination.

Following the stages relating to the cultivation, the harvesting of the grapes and the transporting, the product arrives at the winery where, now, it proceeds immediately to the vinification.

The grape is then offloaded into the hopper of an appropriate apparatus and then mechanically crushed separating the grape marc from the grape must.

Now, it proceeds to carry out a phase of manual cleaning or washing of the grape.

This washing is ineffective in the elimination of antiparasitics and pesticides which, more often, are used during cultivation.

In addition, the traditional washing does not allow efficient elimination of air pollution that inevitably deposits on the grape and this has effect, of course, on the quality and healthiness of the wine produced.

The phytosanitary products are often used in agriculture to preserve the integrity of the final product, but their overuse has led to various environmental and oenological problems.

The volatility of these compounds, and hence their transportation for long distance, results in a widespread environmental contamination that is transmitted to the food products.

For example, the copper on the grape may be a result from treatments done in field with products based on such a metal.

Massive copper doses are found on organic grapes, due to repeated treatments with copper sulphate.

Copper is the main cause of stuck fermentation due to the toxic effect of this metal against yeast cells and is deleterious for the quality of some types of wine that base their organoleptic characteristics on thiol aroma, since it combines with these and precipitates, removing them.

Zinc is naturally present in traces of musts and wines, of which the contamination can occur in vineyards due to dithiocarbamate based pesticides treatments. An excess of zinc in wine, however, has a toxic effect on the human health.

Lead is a very toxic element as it can accumulate in the organism and cause damage to the blood circulatory system, nervous system and renal system.

The presence of such metal on the grape is mainly due to air pollution.

During alcoholic and malolactic fermentation, the concentration of lead decreases as it precipitates in the form of sulfide.

Iron in wine can lead to different forms of instability.

In white wines, iron can react with phosphates present in the wine itself, forming ferric phosphate that can interact with residual proteins, flocculating and precipitating.

In red wines, the iron reacts with phenolic compounds to give a complex soluble that induces an increase in coloration and its evolution towards blue and black.

Subsequently, also this compound flocculates and precipitates, thus causing the disadvantage of the formation of deposits.

Particular attention should be paid to the manganese concentration since the Chinese legislation currently allows for a maximum limit of 2 ppm in wine.

In the light of the foregoing, the underlying problem of the present invention is that to carry out a washing which simultaneously permits an efficient removal of the unwanted substances from the grape particularly in the vinification process, while allowing the preservation of the product and especially its organoleptic qualities during such washing.

The principal task of the present invention is to provide a plant for washing and a process of washing that gives solution to this problem by solving the drawbacks of the known art.

Within the ambit of this task, a scope of the present invention is therefore, that of providing a process of washing and a pant for washing which allow to easily remove from the grape to be washed foreign bodies, phytosanitary products and metallic substances.

A further scope of the present invention is that of guaranteeing an accurate washing, but at the same time delicate on the grape for vinification.

In particular, a scope of the present invention is to propose a process of washing and a relative plant for washing, eligible to guarantee a drastic reduction in the concentration of phytosanitary products in the grape while preserving the natural and organoleptic characteristics of the latter, in view of subsequent stages of treatment.

Another scope of the present invention is to provide a plant and a process through which the decaying grape can effectively be eliminated, as well as any insect present, as well as those elements which can negatively affect the fermentation and stability of the wine.

This task, as well as these and other purposes that will become apparent hereinafter, are achieved by a plant for washing and a process of washing grape according to the attached independent claims.

Features in detail of the plant and process according to the invention are referred in the dependent claims.

The washing of the grape prior to the pressing, according to the present invention, has many advantages also at fermentation level.

Advantageously, the plant and the process of washing of the grape, object of the present invention, comprises successive stages of washing, both chemical and mechanical washing, such as to allow to reduce drastically the concentration of metals present on the grape such as copper, zinc, iron and lead.

Advantageously due to effect of the washing technology according to the invention, there is also a drastic reduction of the microbial load which, in some cases, includes classes of deleterious micro-organisms for the wine quality.

In fact, the plant and the process of washing according to the invention, allow a drastic reduction in stuck fermentation that takes place instead of the application of traditional practices, thanks to the consistent removal of toxic substances for the yeast cell such as copper and pesticides.

In addition, the washing according to the invention has the advantage of allowing rapid fermentation and linear, both with the use of LSA and with indigenous yeasts.

A further advantage of washing the grape according to the present invention, is to allow an efficient removal of copper so as to obtain a greater typical characteristics of the thiolic wines.

In general, a process of washing according to the present invention has the particular peculiarity of comprising a first and a second washing stage such as to preserve the integrity and organoleptic qualities of the grape:
a first washing stage apt for removing substances and/or foreign bodies from food products, at least through the effect of chemical agents which preferably comprise an acid, advantageously citric, or a base, preferably obtained from the dissolution of a bicarbonate;
a second washing stage suitable to remove these chemical agents from the grape.

Advantageously, the first washing stage provides the immersion of the grape in a bath and a mechanical action apt to promote the removal of substances and/or foreign bodies from said food products.

Preferably, the mechanical action is carried out through bubbling of the bath advantageously by injecting air into the bath itself and/or by generating bubbles through ultrasonic vibration induced cavitation.

Such cavitation can be induced by ultrasonic vibrators.

Preferably, the first washing stage provides an immersion time in said bath between 30″ and 10′, advantageously between 40″ and 8′ and more preferably between 60″ and 4′.

The chemical agents also include chelating agents for removing metals from said food products.

Preferably, also the second washing stage provides the immersion into a bath where ozonated water is advantageously utilized.

Particularly, but not exclusively, when both an acid washing, in the first washing stage and the washing with ozonated water, in the second washing stage is provided, a third washing stage is preferably provided in between the first washing stage and the second a washing stage that advantageously provides a jets of water washing.

Advantageous a fourth washing stage is provided prior to the first and preferably carried out by means of jets of water of an intensity, appropriate not to damage the grape while still effectively rinsing it.

Prior to the first washing stage, advantageously a removal stage is provided preferably manual for the removal of foreign bodies and/or rotten products from said food products.

To conclude the process of washing according to the present invention, it is advantageously provided a drying stage of the grape which involves at least partial removal of the water outside the grape preferably to reduce the amount of this water to a value not exceeding 2% by mass.

This drying stage is preferably carried out either by jets of air or by freezing to −4° C. of the water outside the grape, preferably by the use of liquid nitrogen, and successive mechanical removal of the frozen water.

Such mechanical removal can take place during the grape pressing stage by means of a filter separating the ice phase from the grape juice phase.

Another advantageous aspect of a process of washing according to the present invention is to provide a temperature regulation of the grape, to supply grape, especially when this is grape for white wines, at a temperature preferably ranging from 2° C. to 15° C. and more preferably between 4° C. and 5° C.

In general, a plant for washing of products according to the present invention is configured to carry out the process of washing mentioned above.

Further features and advantages of the invention will become more apparent from the description of a preferred but not exclusive embodiment of the plant and the washing process of the grape according to the invention, illustrated by way of non-limiting example in the accompanying drawings, in which:

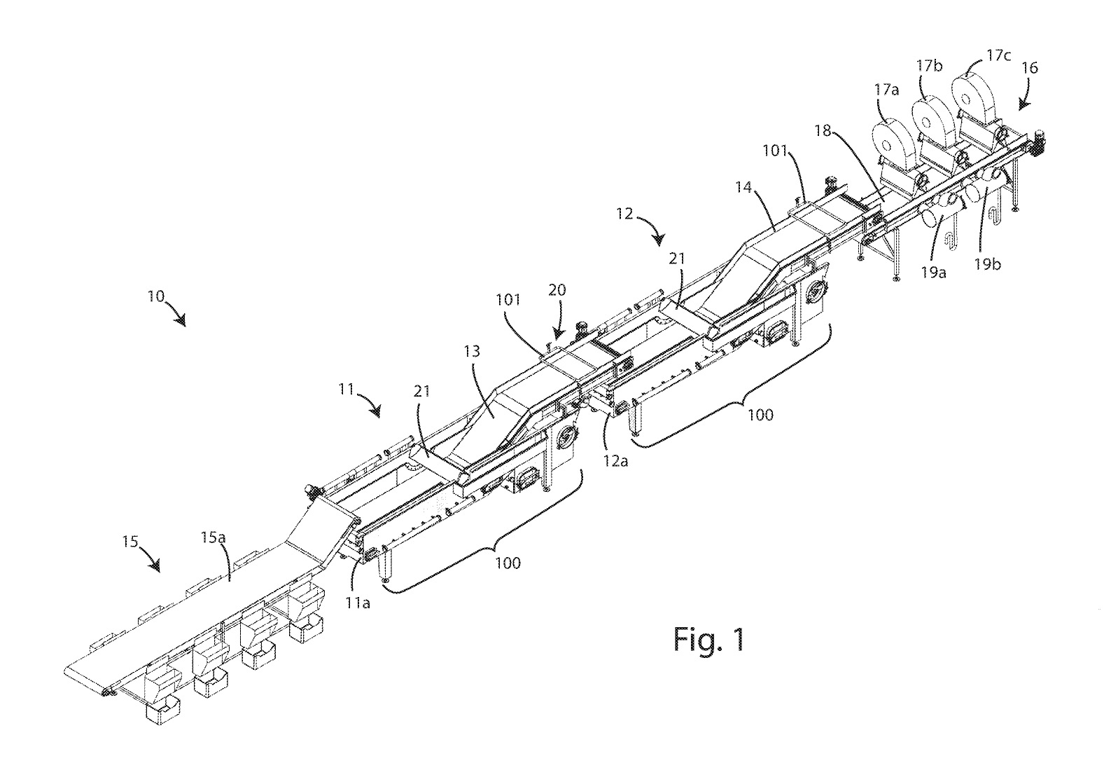

FIG. 1 shows a plant for washing according to the present invention in perspective view;

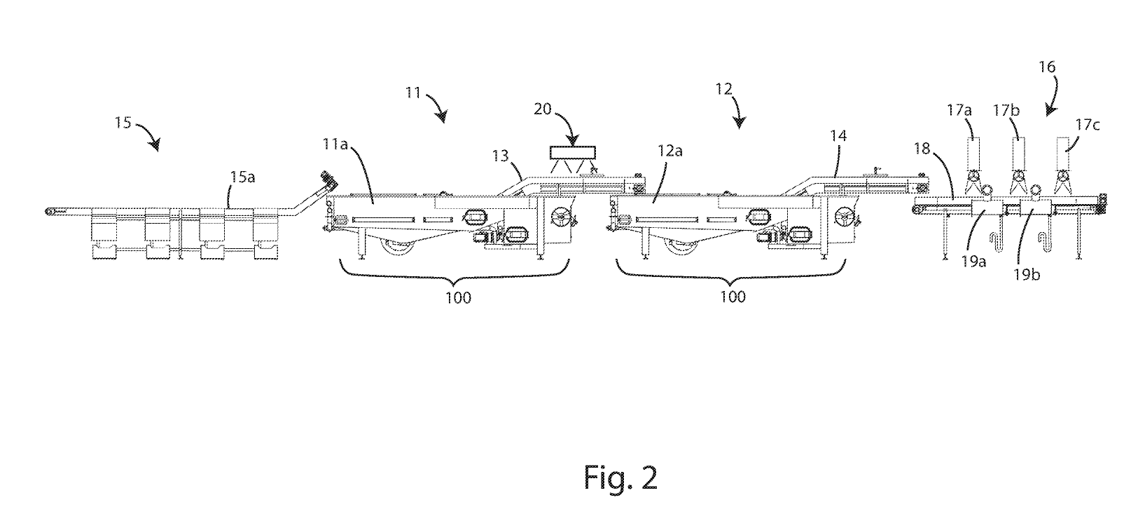

FIG. 2 illustrates the implant of FIG. 1 in the side view.

With particular reference to the figures cited, it is generally indicated with 10 a plant for washing grape.

In its most general form, a plant according to the present invention comprises a first washing section 11, preferably provided with a first bath 11a, and a second washing section 12, preferably provided with a second bath 12a.

In the baths 11a and 12a, preferably, a conveyor belt 13 and 14 is provided configured for advancing the grape into the respective bath 11a or 12a and extracting them from the latter.

Advantageously, the feed rate of conveyor belt 13 or 14 is adjustable to regulate the residence time of the grape in immersion in the bath.

Preferably, at least in the first bath 11a, a device suitable for removing sediments that deposit at the bottom of the bath 11a and/or 12a during washing is provided.

In addition, it is advantageously provided, at least in the first bath 11a, a device suitable for removing floating bodies in the bath of the first and/or of the second bath 12a.

The first washing section 11 is provided with chemical agents input means.

The washing section 12 can also be realized by means of sprayers, instead of a bath.

The first washing section 11 is advantageously provided with means for obtaining bubbling washing.

These means may include air injection nozzles in a washing bath for grape or ultrasonic vibrators connected to the first bath 11a and configured to induce the cavitation of the water in this container.

In particular, making reference to a preferred embodiment, schematized in the figures cited above, the plant for washing grape 10 comprises a removal section 15, upstream of the washing sections 11 and 12, and advantageously also a drying section 16, downstream of washing sections 11 and 12.

The removal section 15 is adapted to allow the manual selection of the grapes and the removal of unwanted parts or bodies from the grapes entering the first washing section 11 and is provided with a conveyor belt 15a for the advancement the grapes.

The drying section 16, in the embodiment illustrated in the accompanying figures, comprises three blowing units 17a, 17b and 17c located above a discharge conveyor belt 18.

In this embodiment, there are also provided two suction units 19a and 19b located below the discharge conveyor belt 18.

In general, the drying section 16 preferably comprises at least one blowing unit and/or at least one suction unit.

Advantageously, the plant 10 comprises an intermediate washing section 20 which is in between the washing sections 11 and 12.

Advantageously, the conveyor belt 13 of the first washing section 11 has an external portion to the first bath 11a and arranged in correspondence with the intermediate washing section 20 which preferably comprises water sprayers arranged to bedew the grape transported by said conveyor belt.

Operatively, the grape is discharged onto a conveyor belt 15a on which a manual visual selection occurs.

In this stage, the operators view the grapes and eliminate the rasp, rotten grapes and other coarse impurities that may be present.

Successively the grape is then preferably transported to a pre-washing section, not shown, which advantageously consists of a spray system.

Here dust and dirt present are removed from the grape.

The grape, then, dragged by the conveyor belt 13, passes through the first bath 11a.

In this first bath 11a preferably contains a chemical, acidic or basic agent, which can reduce the concentration of pesticides and micro-organisms present on the grape.

Such chemical agent preferably comprises an acid, and advantageously citric acid, or a base, preferably gotten from sodium bicarbonate solution.

In this first bath 11a there are also chemical agents capable of removing the metals present, preferably chelating agents.

In the first bath 11a in addition to the purification by chemical action, there is also a mechanical action due to the effect of bubbler which, emit air from suitable nozzles, preferably present at the bottom of the first bath 11a, facilitate surface separation of the fractions of lighter product, such as rotten grapes, leaves or dirt.

Alternatively, the mechanical action can be carried out by bubbling generated by cavitation.

In this case, ultrasonic vibrators are preferably connected to the bath, advantageously at the bottom of the latter.

Ultrasonic emissions, in fact, cause pressure jumps in the liquid which cause the local vaporization and thus the formation of micro-bubbles of vapor.

In said first bath 11a, preferably, there are present:
a spillway of surface 21, such as to remove the substances that separate, floating on the surface of the liquid, and
a bottom scraper, not illustrated, that removes the heavy substances that precipitate on the bottom of the bath.

The residence time of the grape in the first bath 11a is advantageously adjustable, for example by adjusting the speed of a conveyor belt 13, which is advantageously equipped with palettes for the dragging of the grape.

Varying the residence time, the advantage of being able to adjust, and in particular optimize, the action of chemical and physical removal of the impurities present, is achieved.

Preferably, this residence time in the first bath 11a is between 30 seconds and 10 minutes, and more preferably between 40 seconds and 8 minutes, and still more preferably between 60 seconds and 4 minutes.

Once the established residence time has been reached, the grape is extracted, preferably via the conveyor belt 13, out of the first bath 11a downstream of which advantageously are provided towards the successive washing section by showering and the second bath 12a of washing with water.

The second bath 12a has the aim to eliminate the residue of any chemical agents used in the first washing from the grape.

Also in this second bath, increase of the effect washing can be provided to by the use of bubblers, for example by means of air emitting nozzles or ultrasonic cavitation.

The water temperature in this second bath is preferably such as to bring the grape to a temperature between 2-15° C., and even more preferably between 4-5° C.

The second bath 12a is preferably equipped with temperature control devices.

In another embodiment of the present invention, a third washing bath is provided, not shown, in which the grape is brought in contact with ozonated water.

The ozonated water is a strong oxidant and eliminates the micro-organisms present, in addition it also has the advantage that, as the ozone is unstable, it decays eliminating itself and thus leaves no residue.

In the case that one of the washing bath 11 and/or 12 uses ozonated water, it is preferable to avoid mechanical action, such as bubbling, precisely because, as the ozone is unstable, it will be degraded to gaseous oxygen and removed by the bubbling action.

At exit from the second bath 12a (or from the third bath where provided), the grape is sent to the drying section 16 so as not to have the presence excessive water in the successive pressing section.

The drying operation of the grape, in an alternative embodiment of the present invention, is advantageously carried out by freezing to −4° C. with liquid nitrogen. In this way the water present outside the grape is removed in solid phase while the water contained in the grape remains in liquid phase being rich in sugars and other substances.

An advantageous aspect of the plant for washing according to the present invention is to be modular.

In particular, this plant 10 preferably comprises at least one washing module 100 comprising:
a bath 11a or 12a,
a shower or spray washing device 101 connected to the bath 11a or 12a,
a conveyor 13 or 14 suitable for advancing the products into the bath 11a or 12a and extracting them from it and feeding them in correspondence of the washing device 101.

The plant 10, in the preferred but not exclusive embodiment illustrated in the accompanying figures, advantageously consists in the successive disposition two washing modules 100.

Through a process and plant according to the present invention, the task and the scopes are achieved, in particular by solving the problem of obtaining efficient grape washing, especially for vinification, while preserving the quality and the organoleptic characteristics of the latter.

Practically, in fact, the above-described plant performs a washing through the described means that determines an effective removal of undesirable substances and bodies without damaging the grapes and preferably carrying and/or maintaining it at an optimal temperature for the successive process of vinification.

The process and plant according to the present invention are suitable for washing grape to obtain from these high quality wines.

The invention thus conceived is susceptible of numerous modifications and variations, all of which fall within the scope of the enclosed claims.

In addition, all the details may be replaced by other technically equivalent elements.

In practice, the materials used, as well as the shapes and the size of the contingents, may be varied according to the contingent needs and state of the art.

If the constructive features and techniques mentioned in the following claims are followed by signs or reference numbers, such signs or reference numbers have been assigned with the sole purpose of increasing the intelligibility of the claims themselves and, consequently, they do not constitute no way of limiting the interpretation of each element identified, purely for example, by such signs or reference numbers.

1. Process of washing grapes, especially grapes for Vinification, characterized in that it comprises:
a first stage of automated washing apt for removing substances and/or foreign bodies from the grapes at least through the effect of chemical agents,
a second stage of automated washing apt for removing said chemical agents from said grapes;
said stages of washing being such as to preserve the integrity and the organoleptic quality of the grapes.

2. Process according to claim 1, characterized in that said first washing stage provides the immersion of the grapes in a bath and a mechanical action capable of promoting the removal of substances and/or foreign bodies from the grapes.

3. Process according to claim 2 characterized in that said mechanical action is carried-out through bubbling in said bath.

4. Process according to claim 3 characterized in that said bubbling is obtained by air injection in said bath.

5. Process according to claim 3 characterized in that said bubbling is obtained by cavitation of water of said bath induced by ultrasonic vibrations.

6. Process according to claim 1 characterized in that said chemical agents comprise at least one acid, preferably citric acid.

7. Process according to claim 1 characterized in that said chemical agents comprise at least a base which preferably is derived from dissolving a bicarbonate in said bath.

8. Process according to claim 2 characterized in that said first washing stage provides an immersion time, in said bath, between 30″ and 10′, preferably between 40″ and 8′ and more preferably between 60″ and 4′.

9. Process according to claim 1 characterized in that said chemical agents include chelating agents for removing metals from the grapes.

10. Process according to claim 1, characterized in that said second washing stage provides the immersion in a bath.

11. Process according to claim 1, characterized in that said second phase of w second washing stage provides the use of ozonated water.

12. Process according to claim 1 characterized in that it comprises a third washing stage in between said first washing stage and said second washing stage.

13. Process according to claim 12 characterized in that said third washing stage provides a jet washing of said food products.

14. Process according to claim 1 characterized in that it comprises a fourth washing stage prior to said first washing stage and preferably carried out by means of jets of water.

15. Process according to claim 1 characterized in that it comprises a manual removal stage prior to said first washing stage for removing foreign bodies and/or rotten products from said food products.

16. Process according to claim 1 characterized in that it comprises a drying stage of said food products after said second washing stage, which provides the removing of at least part of the water outside said food product.

17. Process according to claim 16 characterized in that said drying stage is performed in a way to reduce said water outside the grapes to a quantity not more than 2% in mass.

18. Process according to claim 16, characterized in that said drying stage is selectively performed by means of jets of air or by freezing to −4° C. of said water outside said food products and successively, mechanical removal of the frozen water.

19. Process according to claim 1 characterized in that it provides a regulation of the temperature of said food products, in order to provide the grapes at a temperature preferably between 2° C. and 15° C. and preferably between 4° C. and 5° C.

20. A plant for washing food products configured to perform a process of washing according to claim 1.
